(19) United States
(12) Patent Application Publication
(10) Pub. No.: US 2025/0041153 A1
(43) Pub. Date: Feb. 6, 2025

(54) NEGATIVE-PRESSURE MASSAGE CUP DEVICE AND VIBRATOR THEREOF

(71) Applicant: BIBOTING INTERNATIONAL CO., LTD., Taoyuan City (TW)

(72) Inventor: Li-Pin YUAN, TAOYUAN CITY (TW)

(21) Appl. No.: 18/229,580

(22) Filed: Aug. 2, 2023

(51) Int. Cl. A61H 23/02; A61H 9/00

(52) U.S. Cl. CPC A61H 23/0254; A61H 9/0057; A61H 2201/0165

(57) ABSTRACT

A negative-pressure massage cup device and a vibrator thereof are provided. The negative-pressure massage cup device includes a negative-pressure massage cup and a vibrator. The vibrator includes: a seat member having a first clip member and a second clip member; a motor clipped between the first clip member and the second clip member; and a cover member, the cover member and the seat member form a housing in which the first clip member, the second clip member and the motor are enclosed, a partition space is formed between the second clip member and the cover member, the motor and the second clip member are separated from the cover member via the partition space. Accordingly, an impact generated when negative-pressure massage cup falls down is taken by the cover member without transferring to the motor due to the partition space.

### BACKGROUND OF THE DISCLOSURE

### Technical Field

The present disclosure relates to a negative-pressure massage cup, especially to a negative-pressure massage cup device and a vibrator thereof.

### Description of Related Art

A related-art negative-pressure massage cup is connected to a negative-pressure generator, and the negative-pressure massage cup covers a body part of a user. As such, a negative pressure is formed in the negative-pressure massage cup to process a cupping therapy to the body part of the user covered by the negative-pressure massage cup.

The related-art negative-pressure massage cup is fastened with a vibrator at one side thereof to provide vibrations with different frequencies during the cupping therapy.

However, an eccentric motor of the related-art vibrator is fastened in a housing of the vibrator and connected to a front shell of the housing. When the negative-pressure massage cup and the vibrator thereof accidentally fall down, the gravity may be biased toward the vibrator because the vibrator is fastened at one outer side of the negative-pressure massage cup, thus the front shell of the vibrator directly takes an impact while falling down and the impact is directly transferred to the eccentric motor. As such, eccentric components of the eccentric motor may be damaged and the vibrator is in a malfunctioning status.

Accordingly, the applicant of the present disclosure has devoted himself for improving the mentioned shortages.

### SUMMARY OF THE DISCLOSURE

The present disclosure is to provide a negative-pressure massage cup device and a vibrator thereof, in which a partition space used for clipping and fastening a motor is formed between a second clip member and a cover member, thus an impact taken by the cover member is prevented from transferring to the motor to provide an effect of protecting the motor.

Accordingly, the present disclosure provides a vibrator, which includes: a seat member having a first clip member and a second clip member, wherein the first clip member and the second clip member are mutually clipped and fastened, and the second clip member has an outer surface; a motor clipped and fastened between the first clip member and the second clip member; and a cover member correspondingly covering the seat member, wherein the first clip member, the second clip member and the motor are enclosed between the seat member and the cover member, the cover member has an inner surface, the inner surface and the outer surface face each other, a partition space is formed between the inner surface and the outer surface, and the motor and the second clip member are separated from the cover member via the partition space.

Accordingly, the present disclosure provides a negative-pressure massage cup device, which includes: a negative-pressure massage cup having a fastening structure disposed on an outer surface thereof; and an aforesaid vibrator, wherein the seat member is correspondingly fastened on the fastening structure.

Advantages achieved by the present disclosure are as follows. The partition space is formed between the inner surface of the cover member and the outer surface of the second clip member, the impact taken by the cover member is prevented from transferring to the motor, and the eccentric components of the motor are avoided from being damaged when the negative-pressure massage cup device falls down, thus an effect of protecting the motor is provided.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective view showing the negative-pressure massage cup device according to the first embodiment of the present disclosure;

FIG. 2 is a perspective exploded view showing the negative-pressure massage cup device according to the first embodiment of the present disclosure;

FIG. 3 is a perspective exploded view showing the vibrator according to the first embodiment of the present disclosure;

FIG. 4 is a top partially cross-sectional view of FIG. 1 according to the present discourse;

FIG. 5 is a side partially cross-sectional view of FIG. 1 according to the present discourse; and

FIG. 6 is a side partially cross-sectional view showing the negative-pressure massage cup device according to the second embodiment of the present discourse.

### DETAILED DESCRIPTION OF THE DISCLOSURE

The technical contents of this disclosure will become apparent with the detailed description of embodiments accompanied with the illustration of related drawings as follows. It is intended that the embodiments and drawings disclosed herein are to be considered illustrative rather than restrictive.

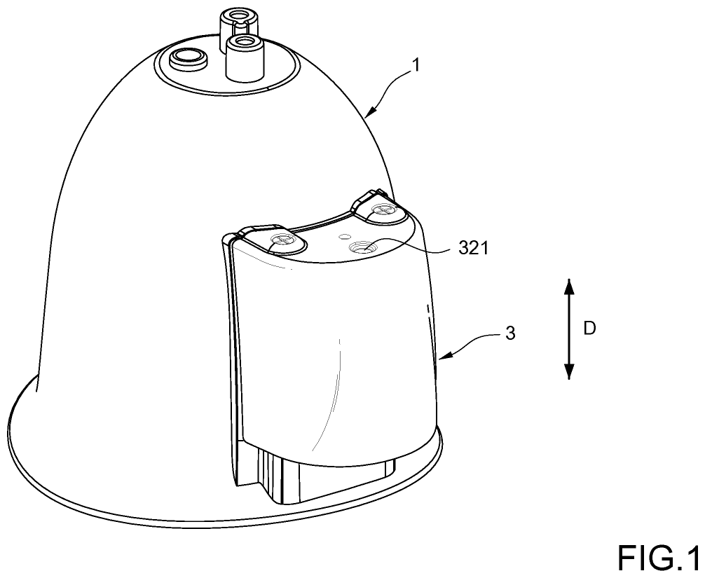

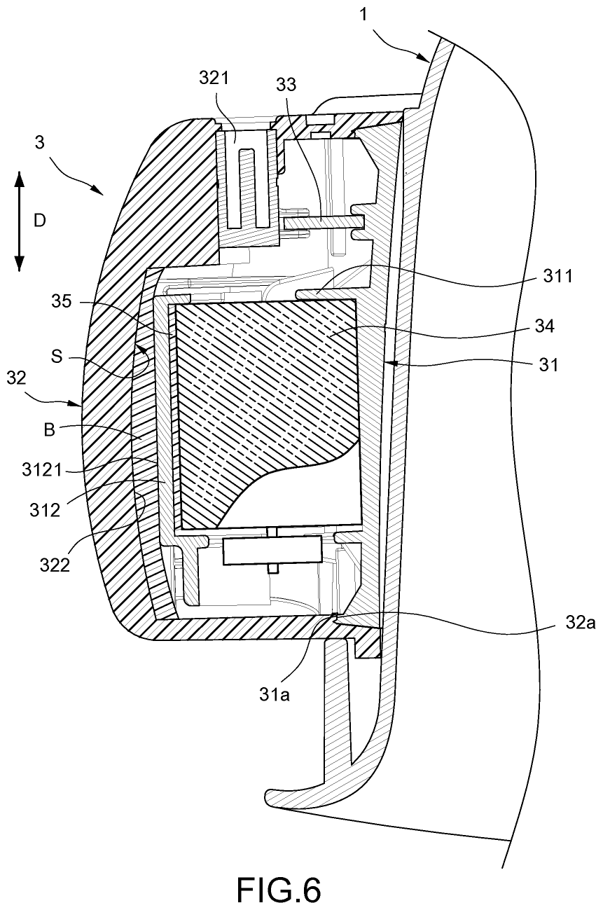

The present disclosure provides a negative-pressure massage cup device and a vibrator thereof. Please refer to FIG. 1, the negative-pressure massage cup device and the vibrator thereof is connected to a negative-pressure generator (not shown in figures), thus a negative-pressure is generated in a negative-pressure massage cup 1 when the negative-pressure massage cup 1 covers on a user to process a cupping therapy at a body part of the user where is covered by the negative-pressure massage cup 1. FIG. 1 to FIG. 5 illustrate the first embodiment of the negative-pressure massage cup device of the present disclosure, and FIG. 6 illustrates the second embodiment of the negative-pressure cup device of the present disclosure.

Please refer from FIG. 1 to FIG. 5. In one of the exemplary embodiments, the negative-pressure massage cup device of the present disclosure includes a negative-pressure massage cup 1 and a vibrator 3. The negative-pressure massage cup 1 is formed as a cup-shaped member and a fastening structure 11 is disposed on an outer surface thereof.

The vibrator 3 includes a seat member 31, a cover member 32 and a motor 34. In one of the exemplary embodiments, the vibrator 3 further includes a circuit board 33 and a plurality of fixing units 36.

The seat member 31 has a first clip member 311 and a second clip member 312 capable of being mutually clipped and fastened. In one of the exemplary embodiments, the first clip member 311 is formed on an inner surface (not labelled). The second clip member 312 is detachedly fastened on the first clip member 311, and the second clip member 312 has an outer surface 3121.

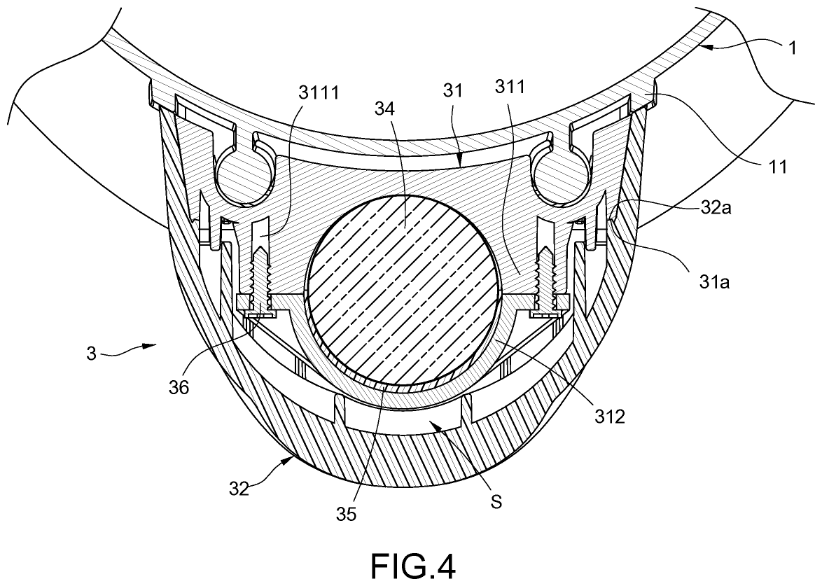

The motor 34 is sandwiched and fastened between the first clip member 311 and the second clip member 312. Please refer to FIG. 4, the motor 34 is sandwiched and fastened between the first clip member 311 and the second clip member 312 which have already been mutually clipped and fastened. The motor 34 is an eccentric motor, thus the motor 34 has eccentric components (not shown in figures).

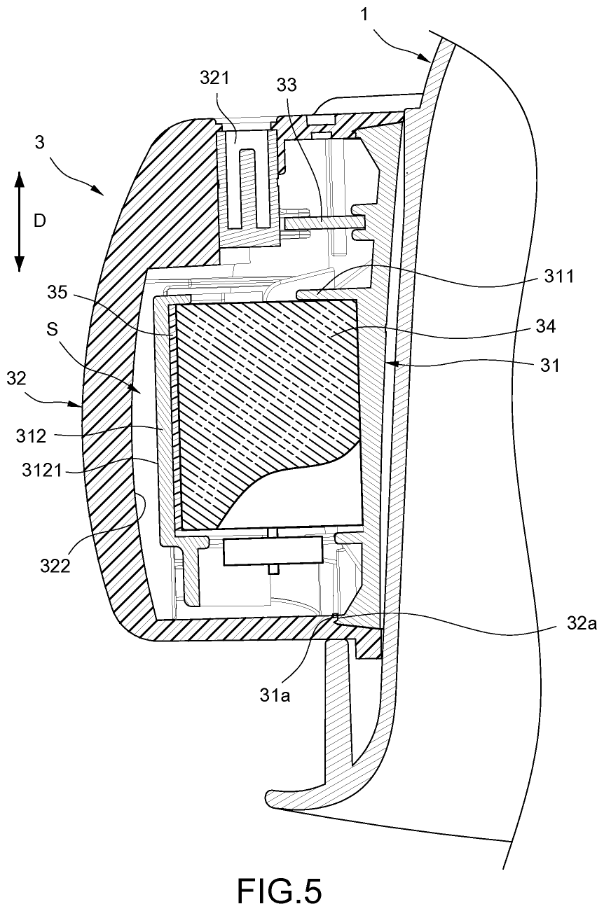

The cover member 32 covers on the inner surface of the seat member 31, the first clip member 311, the second clip member 312 and the motor 34 are enclosed between the seat member 31 and the cover member 32, thus the vibrator 34 of the present disclosure is assembled. Please refer to FIG. 5, the cover member 32 has an inner surface 322, and the inner surface 322 and the outer surface 3121 are correspondingly disposed (or facing each other).

Details are provided as follows. A housing (not labelled) is formed after the seat member 31 and the cover member 32 are mutually assembly, and the first clip member 311, the second clip member 312 and the motor 34 are enclosed in the housing.

Please refer from FIG. 1 to FIG. 5, the vibrator 3 is correspondingly fastened on the fastening structure 11 of the negative-pressure massage cup 1 through the seat member 31. The gravity center of the negative-pressure massage cup 1 is biased toward the vibrator 3 because the negative-pressure massage cup 1 fastens the vibrator 3. When the negative-pressure massage cup device of the present disclosure accidentally falls down, the outer surface (oppositely disposed relatively to the inner surface 322 and not labelled) of the cover member 32 takes a direct impact.

The circuit board 33 is fastened on the inner surface of the seat member 31. The circuit board 33 is also disposed between the seat member 31 and the cover member 32, in other words the circuit board 33 is enclosed in the housing.

In order to prevent the impact taken by the cover member 32 from transferring to the motor 34, the vibrator 3 is formed with a partition space S arranged between the inner surface 322 and the outer surface 3121 as shown in FIG. 5, thus the motor 34 and the second clip member 312 are separated from the cover member 32 due to the partition space S, in other words, the motor 34 and the second clip member 312 are not connected to the cover member 32.

Accordingly, when the negative-pressure massage cup device of the present disclosure accidentally falls down, the outer surface of the cover member 32 takes the direct impact, and the impact taken by the cover member 32 is prevented from transferring to the motor 34 due to the partition space S formed between the inner surface 322 of the cover member 32 and the outer surface 3121 of the second clip member 312, and the eccentric components of the motor 34 are avoided from being damaged when the negative-pressure massage cup device falls down, thus an effect of protecting the motor 34 is provided.

For increasing the protecting effect to the motor 34, the vibrator of the present disclosure further includes a foam 35, the foam 35 is sandwiched between the motor 34 and the second clip member 312. As such, an initial buffering effect generated during the impact is provided due to the foam 35.

The fastening method of the first clip member 311 and the second clip member 312 of the present disclosure are not intended to be limiting. In one of the exemplary embodiments, the first clip member 311 has a plurality of fixing holes 3111, each of the fixing units 36 passes the second clip member 312 and correspondingly fixed in each of the fixing holes 3111, thus the second clip member 312 is detachably fastened on the first clip member 311.

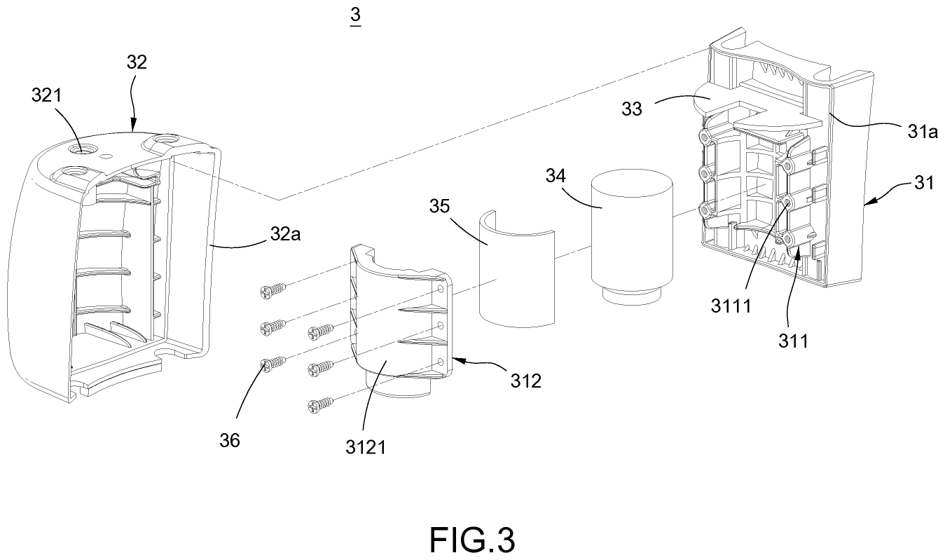

For providing a waterproof effect to the vibrator 3 of the present disclosure, a frame-shaped first circumferential edge 31a and a frame-shaped second circumferential edge 32a are formed at the connecting location of the seat member 31 and the cover member 32 as shown from FIG. 3 to FIG. 5. The first circumferential edge 31a and the second circumferential edge 32a both enclose the first clip member 311, the second clip member 312, the circuit board 33 and the motor 34. As such, after the first circumferential surface 31a and the second circumferential surface 32a are soldered with each other between the seat member 31 and the cover member 32, a watertight status is provided to the housing formed through the seat member 31 and the cover member 32 being mutually assembled, and a desired waterproof effect is provided.

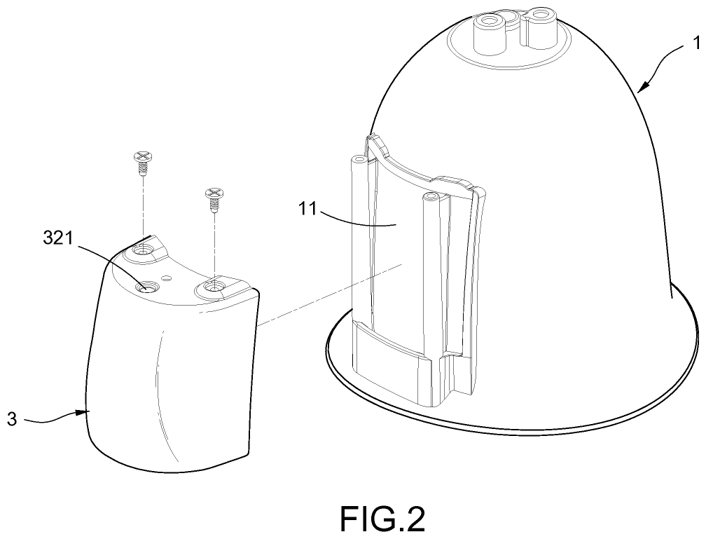

Please refer to FIG. 1, FIG. 2, FIG. 3 and FIG. 5, a guiding direction D is defined on the vibrator 3 of the present disclosure. The guiding direction D is parallel to a power cable (not shown in figures) inserted in the vibrator 3. The cover member 32 is disposed with a power connector (as shown in FIG. 5 but not labelled) along the guiding direction D. The cover member 32 and the power connector jointly form a power insertion port 321 at a location corresponding to the power connector, and an inserted direction of the power insertion port 321 is (or parallel to) the guiding direction D. In one of the exemplary embodiments, the power insertion port 321 is disposed on a top end surface of the cover member 32. As such, the power cable inserted in the power insertion port 321 may smoothly stretch and no twisting situation may occur.

Please refer to FIG. 6, which illustrates another embodiment of the present disclosure. The another embodiment is substantially the same as the aforesaid embodiment, and the difference is that the vibrator 3 further has a buffering component B. The buffering component B is disposed (or filled) in the partition space S, thus a buffering effect is provided by the buffering component B between the inner surface 322 of the cover member 32 and the outer surface 3121 of the second clip member 312, thus a further buffering effect is provided through the buffering component B during the impact, and the protecting effect provided to the motor 34 is further enhanced.

While this disclosure has been described by means of specific embodiments, numerous modifications and variations could be made thereto by those skilled in the art without departing from the scope and spirit of this disclosure set forth in the claims.

What is claimed is:

1. A vibrator, comprising:
a seat member, comprising a first clip member and a second clip member clipped and fastened with each other, and the second clip member comprising an outer surface;
a motor, sandwiched and fastened between the first clip member and the second clip member; and
a cover member, correspondingly covering the seat member, wherein the first clip member, the second clip member and the motor are enclosed between the seat member and the cover member, the cover member comprises an inner surface, the inner surface and the outer surface face each other, a partition space is defined between the inner surface and the outer surface, and the motor and the second clip member are separated from the cover member via the partition space.

2. The vibrator according to claim 1, wherein a foam is sandwiched between the motor and the second clip member.

3. The vibrator according to claim 1, further comprising a buffering component disposed in the partition space to buffer between the cover member and the second clip member.

4. The vibrator according to claim 1, further comprising a plurality of fixing units, wherein the first clip member comprises a plurality of fixing holes, each of the fixing units passes through the second clip member to be correspondingly fixed in each of the fixing holes to make the second clip member be fastened on the first clip member.

5. The vibrator according to claim 1, wherein a first circumferential edge and a second circumferential edge are disposed at a connecting location of the seat member and the cover member, the first clip member, the second clip member and the motor are enclosed by the first circumferential edge, the first clip member, the second clip member and the motor are enclosed by the second circumferential edge, and the first circumferential surface and the second circumferential surface are soldered with each other.

6. The vibrator according to claim 5, further comprising a circuit board, wherein the cover member and the seat member jointly form a housing, the circuit board is fixed in the housing, and the circuit board is enclosed by the first circumferential edge and the second circumferential edge.

7. The vibrator according to claim 1, wherein a guiding direction is defined, and the cover member comprises a power insertion port along the guiding direction.

8. A negative-pressure massage cup device, comprising:
a negative-pressure massage cup, comprising a fastening structure disposed on an outer surface thereof; and
a vibrator, comprising:
a seat member, comprising a first clip member and a second clip member clipped and fastened with each other, and the second clip member comprising an outer surface, wherein the seat member is correspondingly fastened on the fastening structure;
a motor, sandwiched and fastened between the first clip member and the second clip member; and
a cover member, correspondingly covering the seat member, wherein the first clip member, the second clip member and the motor are enclosed between the seat member and the cover member, the cover member comprises an inner surface, the inner surface and the outer surface face each other, a partition space is defined between the inner surface and the outer surface, and the motor and the second clip member are separated from the cover member via the partition space.

9. The negative-pressure massage cup device according to claim 8, a foam is sandwiched between the motor and the second clip member.

10. The negative-pressure massage cup device according to claim 8, wherein the vibrator further comprises a buffering component disposed in the partition space to buffer between the cover member and the second clip member.

11. The negative-pressure massage cup device according to claim 8, wherein the vibrator further comprises a plurality of fixing units, the first clip member comprises a plurality of fixing holes, each of the fixing units passes through the second clip member to be correspondingly fixed in each of the fixing holes to make the second clip member be fastened on the first clip member.

12. The negative-pressure massage cup device according to claim 8, wherein a first circumferential edge and a second circumferential edge are disposed at a connecting location of the seat member and the cover member, the first clip member, the second clip member and the motor are enclosed by the first circumferential edge, the first clip member, the second clip member and the motor are enclosed by the second circumferential edge, and the first circumferential surface and the second circumferential surface are soldered with each other.

13. The negative-pressure massage cup device according to claim 12, wherein the vibrator further comprises a circuit board, the cover member and the seat member jointly form a housing, the circuit board is fixed in the housing, and the circuit board is enclosed by the first circumferential edge and the second circumferential edge.

14. The negative-pressure massage cup device according to claim 8, wherein a guiding direction is defined on the vibrator, and the cover member comprises a power insertion port along the guiding direction.
